(19) United States
(12) Patent Application Publication
(10) Pub. No.: US 2009/0152447 A1
(43) Pub. Date: Jun. 18, 2009

(54) Photo Detector and Photo Detection Apparatus Provided with Photo Detector

(75) Inventors: Takashi Yamada, Tatebayashi-shi (JP); Toshikazu Yanada, Tatebayashi-shi (JP); Shigenori Sekine, Tatebayashi-shi (JP); Shuichi Kawasaki, Shimonoseki-shi (JP); Kota Hagiwara, Shimonoseki-shi (JP)

Correspondence Address: THE WEBB LAW FIRM, P.C., 700 KOPPERS BUILDING, 436 SEVENTH AVENUE, PITTSBURGH, PA, 15219, US

(73) Assignee: NIHON KESSHO KOGAKU CO., LTD., Tatebayashi-shi (JP)

(21) Appl. No.: 12/175,020

(22) Filed: Jul. 17, 2008

(30) Foreign Application Priority Data
Dec. 17, 2007 (JP) 2007-324750

(51) Int. Cl. H01J 40/14

(52) U.S. Cl. 250/214 R

(57) ABSTRACT

It is an object to provide a photo detector that can be arranged in a matrix pattern (in a three-dimensional pattern) and a photo detection apparatus in which the photo detectors are arranged in a matrix pattern (in a three-dimensional pattern). In a photo detector for generating an electrical signal based on the intensity of a light received by a photo detection element, the photo detector comprises a flexible wiring substrate for mounting the photo detection element and the photo detection element electrically connected to the flexible wiring substrate for mounting the photo detection element.

### TECHNICAL FIELD

The present invention relates to a photo detector for generating an electrical signal based on the intensity of a light received by a photo detection element and to a photo detection apparatus provided with the photo detector.

### BACKGROUND ART

Conventionally, for a photo detection apparatus such as an X-ray CT system used in a medical institution or the like, a slice data of a subject is obtained by applying an X-ray to the subject and the internal structure of a desired region of the subject is obtained by repeating the application of an X-ray in an axial direction of the subject.

Such a photo detection apparatus is described in Patent document 1 for instance.

As shown in FIGS. 6 and 7, a photo detection apparatus 100 is composed mainly of a photodiode array 120 in which a plurality of photodiode elements 121 are arranged in a line pattern and a MID substrate 110 in which the upper end surface of a pad formation protrusion 111 is set to be equal in height to the upper surface of the photodiode array 120.

First pads 122 are formed on the upper surface of the photodiode elements 121 disposed on the photodiode array 120, and second pads 112 are formed on the upper end surface of the pad formation protrusion Ill. The corresponding first pad 122 and second pad 112 are electrically connected to each other by a bonding wire 130.

A wiring pattern 113 is formed on the upper surface of the MID substrate 110. First terminals 114 as many as the second pads 112 and one second terminal 115 are formed on the lower surface of the MID substrate 110. The second pads 112 are electrically connected to the first terminals 114 by wirings 140 in a one-to-one correspondence. In addition, the wiring pattern 113 is electrically connected to the second terminal 115.

As shown in FIG. 8, a scintillator array 150 is disposed on the upper surface of the photodiode array 120 in such a manner that scintillators correspond to the photodiode elements 121, respectively. By this configuration, an X-ray in particular having a short wavelength is converted into a visible light and an electrical signal at a single slice of a subject can be generated based on the intensity of a light received by the photodiode array 120. The scintillator array 150 is composed of scintillator elements 151 and separators 152, in which the separator 152 is disposed between the scintillator elements 151.

For the photo detection apparatus 100, as shown in FIG. 9, the photo detection apparatus 100 shown in FIG. 8 are arranged in a line pattern (in parallel with each other) (in a two-dimensional pattern), thereby enlarging the effective X-ray receiving area per unit area of the X-ray CT system for instance and improving the detection efficiency thereof.

Patent document 1: Japanese Patent Application Laid-Open Publication No. 2003-84066

### DISCLOSURE OF THE INVENTION

### Problems to be Solved by the Invention

Such a conventional photo detection apparatus enables an arrangement in a matrix pattern in the both directions of the vertical direction and horizontal direction (in a three-dimensional pattern). However, the arrangement depends on a position accuracy of a pin for outputting a signal on a photo detection element substrate and a fixed-position accuracy to a mounting substrate including a signal amplifying and converting circuit, to which a photo detector is mounted.

Moreover, in the case in which photo detectors having such a structure are arranged in a three-dimensional pattern in the X-ray CT system for instance, as shown in FIG. 10, a mounting substrate 170 to which an amplifier, an A/D converting circuit, a signal conditioning circuit such as a buffer and so on are mounted becomes longer in a longitudinal direction, thereby enlarging the entire photo detection apparatus. The configuration leads to a problem for rotating the photo detection apparatus in the X-ray CT system. Furthermore, as the number of the photo detection substrates arranged in a three-dimensional pattern increases, a wiring density of the mounting substrate becomes higher. Therefore, the mounting substrate becomes costly and it is hard to maintain a high reliability thereof.

The present invention was made in consideration of such conditions, and an object of the present invention is to provide a photo detector that can be arranged in a matrix pattern (in a three-dimensional pattern) and a photo detection apparatus in which the photo detectors are arranged in a matrix pattern (in a three-dimensional pattern).

### Means for Solving the Problems

The present invention was made in order to solve the above problems of the conventional art and to achieve the purpose.

A photo detector in accordance with the present invention generates an electrical signal based on the intensity of a light received by a photo detection element, and comprises a flexible wiring substrate for mounting the photo detection element and the photo detection element electrically connected to the flexible wiring substrate for mounting the photo detection element.

In the case in which the photo detection element is formed on the flexible wiring substrate for mounting the photo detection element as described above, the photo detection element can be aligned and fixed independently for every flexible wiring substrate for mounting the photo detection element. Consequently, in the case in which the photo detectors are arranged in a matrix pattern (in a three-dimensional pattern), a position accuracy of the photo detectors can be improved.

Moreover, since the wiring substrate has flexibility, the wiring substrate can be bent down below the photo detector. Consequently, since the mounting substrate can be disposed below the photo detector, the entire photo detection apparatus can be miniaturized and the photo detection apparatus can be easily rotated in the X-ray CT system.

Accordingly, in the case in which the photo detector is used in the X-ray CT system for instance, a desired region of the subject can be examined for a short time, a volume of X-rays irradiated to the subject can be reduced, and an availability factor of the apparatus can be improved.

In the photo detector in accordance with the present invention, the flexible wiring substrate for mounting the photo detection element is connected to the photo detection element by a bonding wire.

By the above configuration, the photo detection element can be reliably connected to the flexible wiring substrate for mounting the photo detection element, thereby enabling a desired electrical signal to be reliably obtained.

In the photo detector in accordance with the present invention, the flexible wiring substrate for mounting the photo detection element is connected to the photo detection element by a ball grid array (BGA).

By the above configuration, the flexible wiring substrate for mounting the photo detection element can be connected to the photo detection element in the size of the photo detection element. Consequently, in the case in which a plurality of photo detection elements is arranged, adjacent photo detection elements can be disposed without an interspace between the photo detection elements, thereby enabling an efficient arrangement.

In the photo detector in accordance with the present invention, the photo detection element is electrically connected to one side face of the flexible wiring substrate for mounting the photo detection element and a reinforcing board is formed on the other side face.

By forming the reinforcing board as described above, the photo detection element can be effectively prevented from being damaged due to an unreasonable force applied to the photo detection element of the photo detector in particular, thereby enabling the photo detector to be handled safely.

In the photo detector in accordance with the present invention, the photo detection element configures an element aggregate composed of a plurality of photo detection elements.

The element aggregate composed of a plurality of photo detection elements as described above can be easily handled as compared with separate photo detection elements. In addition, even in the case in which a plurality of photo detectors is arranged, the arranging operation can be easily carried out.

In the photo detector in accordance with the present invention, the element aggregate is composed of a plurality of photo detection elements arranged in a line pattern.

In the case in which the element aggregate is formed in a line pattern as described above, a predetermined area required for photo detection can be ensured by arranging a plurality of element aggregates.

Moreover, even in the case in which predetermined areas required for photo detection are different from each other depending on each apparatus, the size of the photo detector is adjustable, thereby enabling the photo detector in accordance with the present invention to be used for apparatuses of various sizes.

In the photo detector in accordance with the present invention, the element aggregate is composed of a plurality of photo detection elements arranged in a matrix pattern.

In the case in which the element aggregate is formed in a matrix pattern as described above, the photo detectors can be arranged in a wider range as compared with the above line pattern case.

Consequently, the photo detector in accordance with the present invention can be used for apparatuses of more various sizes.

The photo detector in accordance with the present invention further comprises a scintillator element disposed on the position corresponding to the photo detection element, in which the scintillator element converts a light having a predetermined wavelength into a visible light.

By the above configuration, not only a normal light but also a radioactive ray having a short wavelength can be converted into a visible light via the scintillator element, and the visible light can be received by the photo detector to generate an electrical signal based on the intensity of the light. Consequently, the photo detector can be suitably used for an X-ray CT system in particular.

In the photo detector in accordance with the present invention, the light having a predetermined wavelength is an X-ray.

In the case in which the light having a predetermined wavelength is an X-ray as described above, the photo detector can be suitably used for an X-ray CT system for appropriately obtaining the internal state of the subject.

In the photo detector in accordance with the present invention, the photo detection element is a photodiode.

In the case in which the photo detection element is a photodiode as described above, since the photodiode has a high speed and sensitivity, the strength of a light can be accurately measured, and the photo detector can be suitably applied to the field of medical instruments in particular.

In the photo detector in accordance with the present invention, the flexible wiring substrate for mounting the photo detection element is a TAB tape.

In the case in which the flexible wiring substrate for mounting the photo detection element is a TAB tape as described above, since the bending strength and twisting strength of the cable are large in particular, the photo detector can be suitably used in the rotating state for an X-ray CT system for instance.

In a photo detection apparatus in accordance with the present invention, the photo detectors according to the above description are arranged in a line pattern.

By arranging the photo detectors in a line pattern as described above, a predetermined area required for photo detection can be ensured.

In a photo detection apparatus in accordance with the present invention, the photo detectors according to the above description are arranged in a matrix pattern.

In the case in which the photo detectors are arranged in a matrix pattern as described above, a larger photo detection area can be obtained as compared with the above arrangement in a line pattern, and the photo detectors can be applied to apparatuses of various sizes.

### EFFECT OF THE INVENTION

By the present invention, it is possible to provide a photo detector that can be arranged in a matrix pattern (in a three-dimensional pattern) and a photo detection apparatus in which the photo detectors are arranged in a matrix pattern (in a three-dimensional pattern).

### BRIEF DESCRIPTION OF THE DRAWINGS

FIG. 1 is an exploded perspective view showing a photo detector in accordance with an embodiment of the present invention.

FIG. 2 is a schematic perspective view showing a photo detector in accordance with an embodiment of the present invention.

FIG. 3 is a schematic perspective view showing a photo detector in which photo detection elements are arranged in a matrix pattern.

FIG. 4 is a schematic perspective view showing a photo detection apparatus provided with a photo detector in accordance with an embodiment of the present invention.

FIG. 5 is a schematic perspective view showing the photo detection apparatus shown in FIG. 4, in which scintillator elements are disposed on the photo detector elements.

FIG. 6 is an exploded perspective view showing a conventional photo detection apparatus.

FIG. 7(a) is a schematic perspective view showing a conventional photo detection apparatus, and FIG. 7(b) is a vertical cross-sectional view of FIG. 7(a).

FIG. 8 is a schematic perspective view showing a conventional photo detection apparatus.

FIG. 9 is a schematic perspective view showing a conventional photo detection apparatus.

FIG. 10 is a schematic perspective view showing a conventional photo detection apparatus.

### EXPLANATIONS OF LETTERS OR NUMERALS

10: Photo detector
20: Element aggregate
22: Photo detection element
30: Flexible wiring substrate for mounting a photo detection element (flexible wiring substrate)
40: Reinforcing board
50: Photo detection apparatus
60: Scintillator element
70: Mounting substrate
100: Photo detection apparatus
110: MID substrate
111: Pad formation protrusion
112: Second pad
113: Wiring pattern
114: First terminal
115: Second terminal
120: Photodiode array
121: Photodiode element
122: First pad
130: Bonding wire
140: Wiring
150: Scintillator array
151: Scintillator element
152: Separator
170: Mounting substrate

### BEST MODE OF CARRYING OUT THE INVENTION

An embodiment (example) of the present invention will be described below in detail with reference to the drawings.

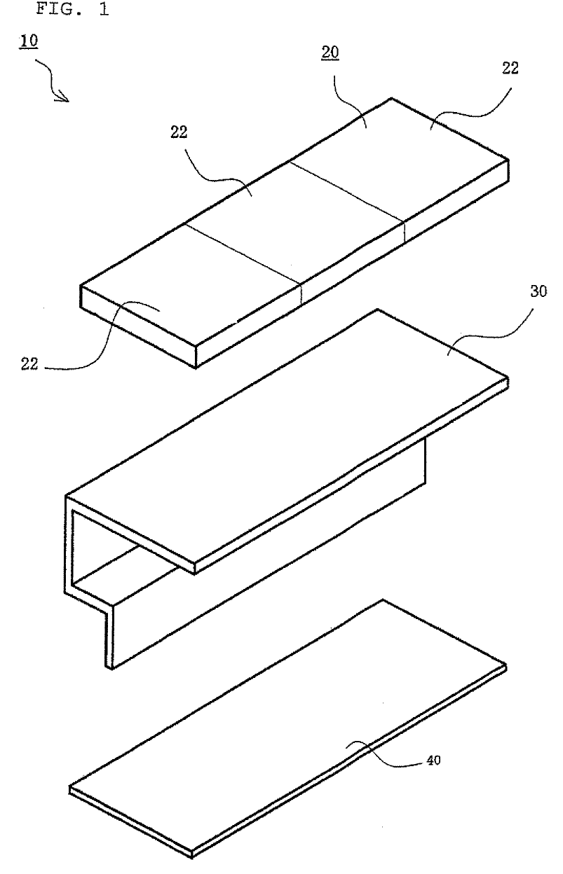

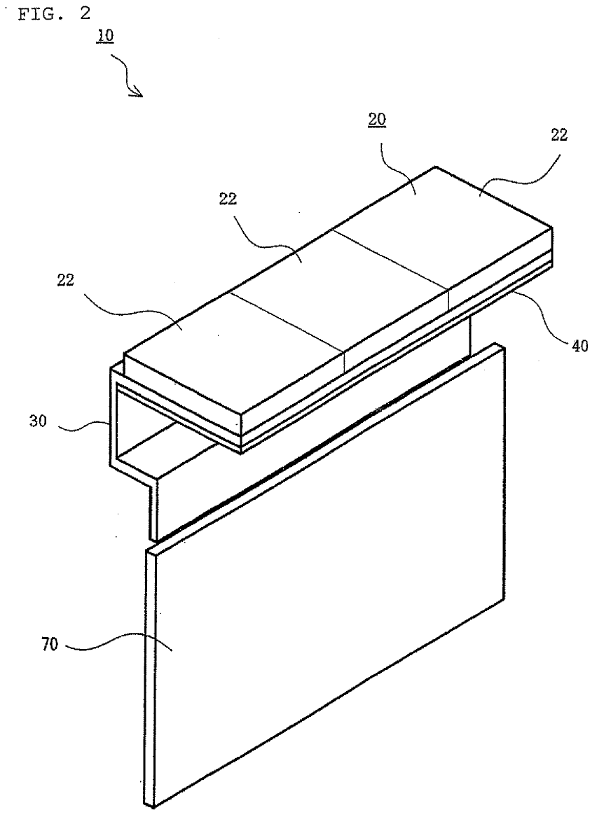

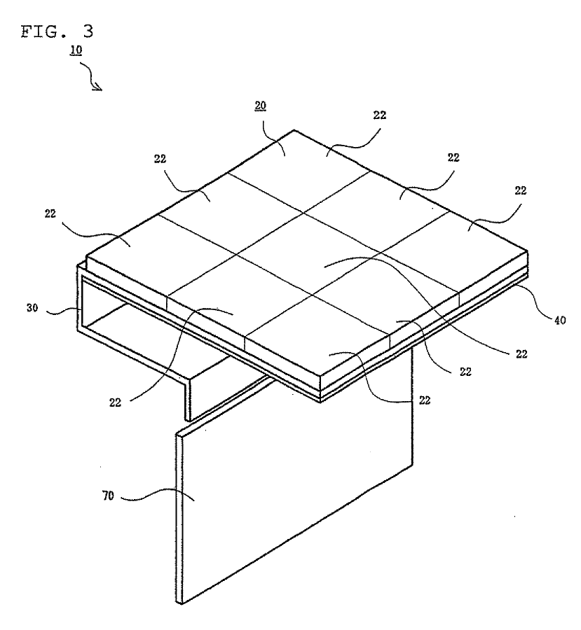

FIGS. 1 to 3 show a photo detector in accordance with an embodiment of the present invention. FIG. 1 is an exploded perspective view showing a photo detector in accordance with an embodiment of the present invention. FIG. 2 is a schematic perspective view showing the photo detector. FIG. 3 is a schematic perspective view showing a photo detector in which photo detection elements are arranged in a matrix pattern.

As shown in FIG. 1 or 2, a photo detector 10 in accordance with the present invention is for generating an electrical signal based on the intensity of a light received by a photo detection element and is used in an X-ray CT system for instance. A slice photograph of a subject is obtained by applying an X-ray to the subject, and the internal structure in the desired region of the subject is obtained by repeating the application of an X-ray in an axial direction of the subject.

The structure of the photo detector in accordance with the present invention is different from that of a similar apparatus of the conventional art. The principle of the photo detector and the photo detection apparatus and a method for using them are basically equivalent to those described in Patent document 1.

“Light (photo)” described in the present specification represents so-called a light in a broad sense in the range of a very low frequency wave having a wavelength of approximately 10 km to a gamma ray having a wavelength of approximately 10 pm. An X-ray and a radioactive ray are included in the “light (photo)” described in the present specification.

The photo detector 10 in accordance with an embodiment of the present invention is composed mainly of a flexible wiring substrate 30 for mounting a photo detection element (hereafter, also referred to as flexible wiring substrate 30), a plurality of photo detection elements 22 electrically connected to one side face (upper surface in FIG. 1) of the flexible wiring substrate 30, and a reinforcing board 40 attached to the other side face (lower surface in FIG. 1). The flexible wiring substrate 30 is disposed between the photo detection elements 22 and the reinforcing board 40, thereby causing a three-layer structure.

The plurality of photo detection elements 22 (three photo detection elements 22 in FIG. 1) forms an element aggregate 20. As the photo detection element 22, there can be mentioned for instance a photodiode of a PN junction type made of a compound semiconductor such as Si and GaAs, a photodiode of a PIN type, a phototransistor, a charge coupled device (CCD), and a photoresistor made of cadmium sulfide (CdS). However, the photo detection element 22 is not restricted in particular in the case in which the element can convert a light into an electrical signal. For the purpose of detecting an X-ray in particular, it is preferable to use a photodiode having an excellent speed and sensitivity as the photo detection element 22.

A wire bonding (not shown) is carried out between the photo detection element 22 and the flexible wiring substrate 30 in such a manner that an electrode pad (not shown) of the photo detection element 22 is electrically connected to an electrode pad (not shown) of the flexible wiring substrate 30.

The flexible wiring substrate 30 is composed mainly of an insulated substrate, a wiring pattern made of copper formed on at least one face of the insulated substrate, and an insulating protective layer formed on the wiring pattern except for the terminal area of the wiring pattern for instance.

The flexible wiring substrate 30 is bent on at least one line. FIG. 1 shows an example of the flexible wiring substrate 30 bent on three lines.

As a method for electrically connecting the photo detection element 22 to the flexible wiring substrate 30, a connection by a Ball Grid Array (BGA) is also possible for instance.

As the flexible wiring substrate 30, there can be mentioned for instance a Flexible Printed Circuit (FPC), a Tape Automated Bonding (TAB) tape, a Chip ON Film (COF) tape, a Tape Ball Grid Array (T-BGA) tape, a Chip Size Package (CSP) tape, an Application Specific Integrated Circuit (ASIC) tape, a two-metal (double-sided wiring) tape, and a multilayer wiring tape. However, the flexible wiring substrate 30 is not restricted in particular in the case in which the wiring substrate has flexibility.

In the case in which the photo detector in accordance with the present invention is used in the X-ray CT system as describer later, the satisfactory flexibility and a fine wiring width in the range of 5 to 50 μm are required. Consequently, the flexible wiring substrate 30 preferably includes the insulated substrate made of a polyimide film having a thickness of 50 μm or less, preferably in the range of 10 to 40 μm, and the wiring pattern made of copper having a thickness of 15 μm or less, preferably in the range of 3 to 8 μm. In particular, it is preferable that the flexible wiring substrate 30 is a TAB tape (manufactured by MITSUI MINING & SMELTING CO., LTD. for instance).

The reinforcing board 40 supports the flexible wiring substrate 30 and the photo detection element 22 from the lower surface side of the flexible wiring substrate 30 to prevent the photo detection element 22 connected to the flexible wiring substrate 30 from being damaged. Consequently, the reinforcing board 40 is not restricted in particular in the case in which the material thereof has strength for serving the purpose. As a material of the reinforcing board 40, a metal, ceramics, plastics, and a compound thereof can be mentioned preferably. Among them, aluminum and ceramics are suitable for the reinforcing board 40 of the photo detector 10 since sufficient processability and strength can be obtained.

Similarly to the photo detection apparatus described in Patent document 1, the photo detector 10 composed of the above members receives a predetermined light by the photo detection element 22 and converts the received light into an electrical signal to obtain a desired data.

For the photo detector 10 shown in FIG. 1 or 2, the photo detection elements 22 are arranged in a line pattern (three elements in FIG. 1 or 2). However, the photo detection elements 22 can also be arranged in a matrix pattern as shown in FIG. 3 (nine elements in FIG. 3). In the both cases, the configuration shown in the figure represents one photo detector 10. In practice, one photo detection element 22 is approximately 1-mm square, and approximately 30×30 photo detection elements arranged in a matrix pattern are handled as one photo detector.

For the photo detector 10 in accordance with the present invention, since a substrate for connecting the photo detection element 22 is the flexible wiring substrate 30 having flexibility, the wiring substrate can be bent down below the photo detector. Consequently, as shown in FIG. 2, a mounting substrate 70 to which an amplifier, an A/D converting circuit, a signal conditioning circuit such as a buffer and so on are mounted can be disposed below the photo detector 10.

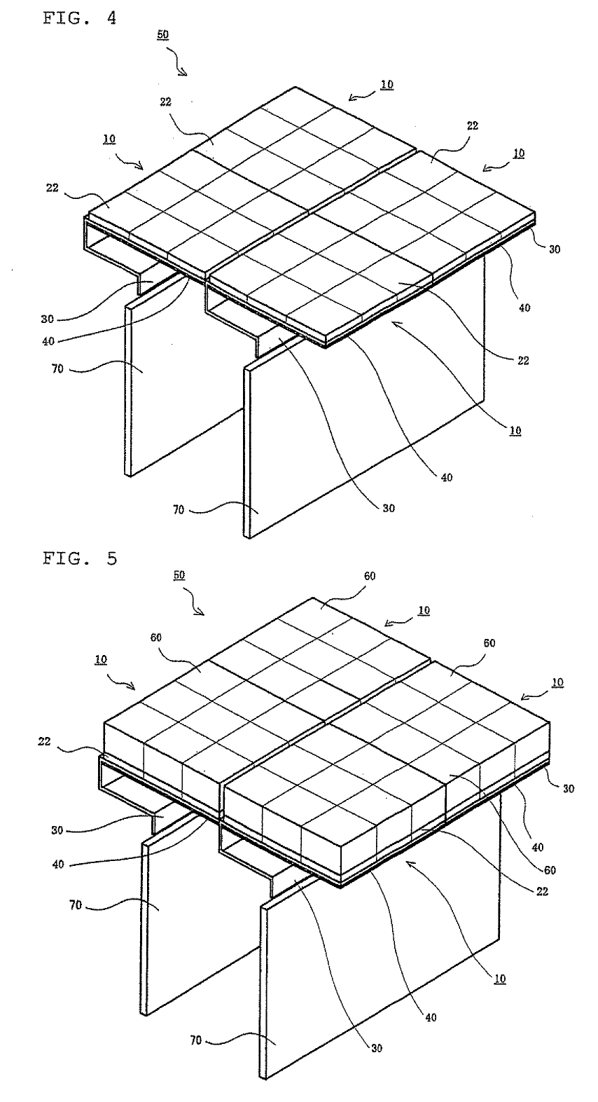

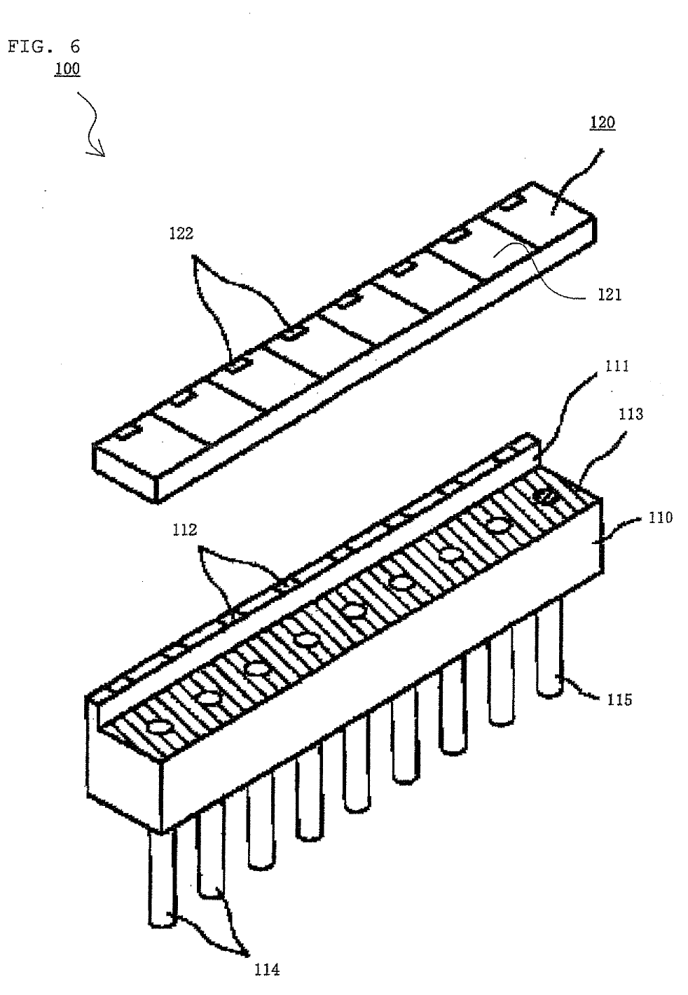

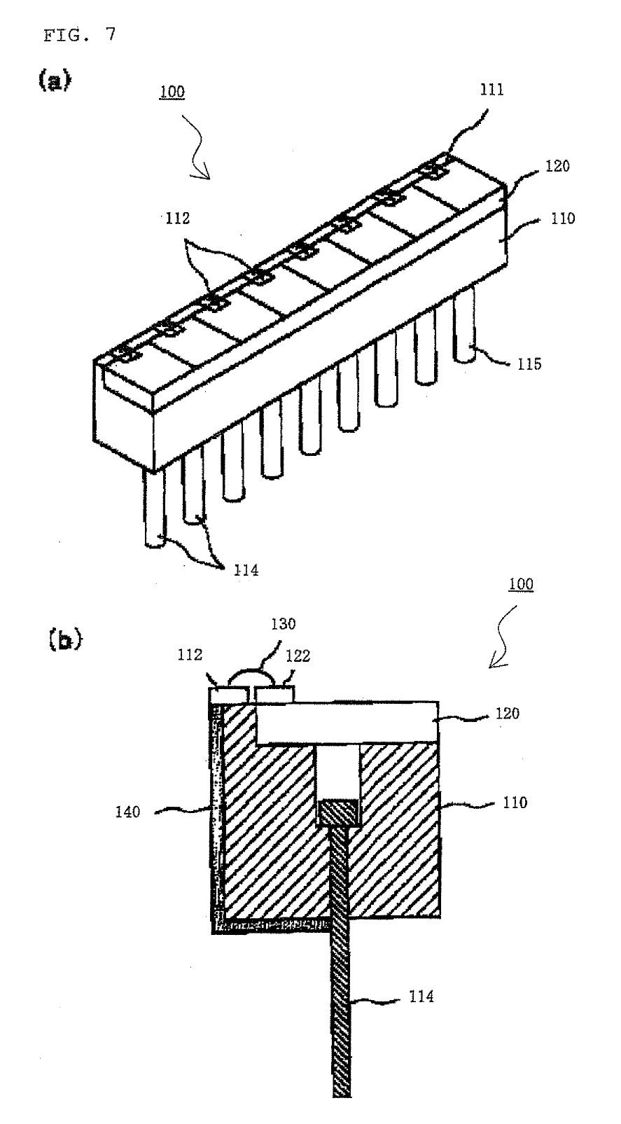

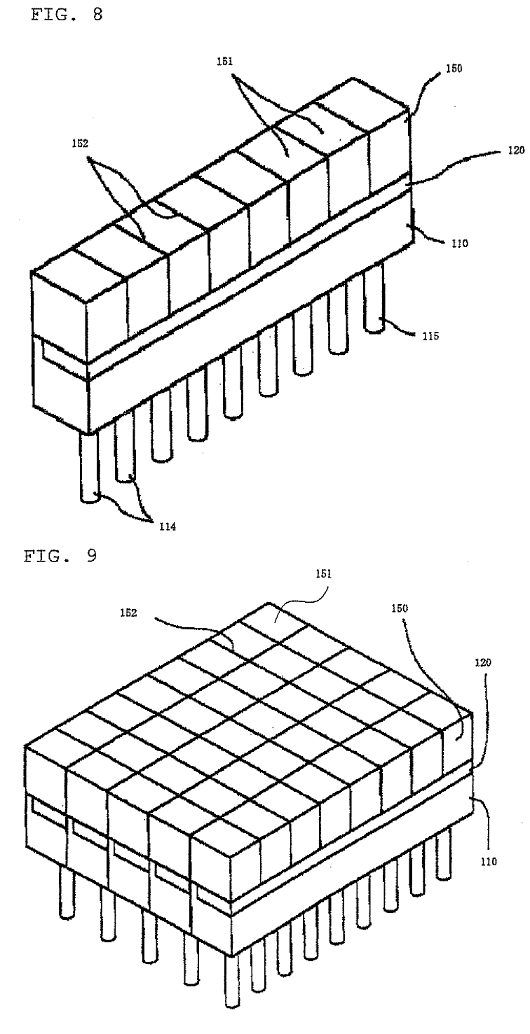

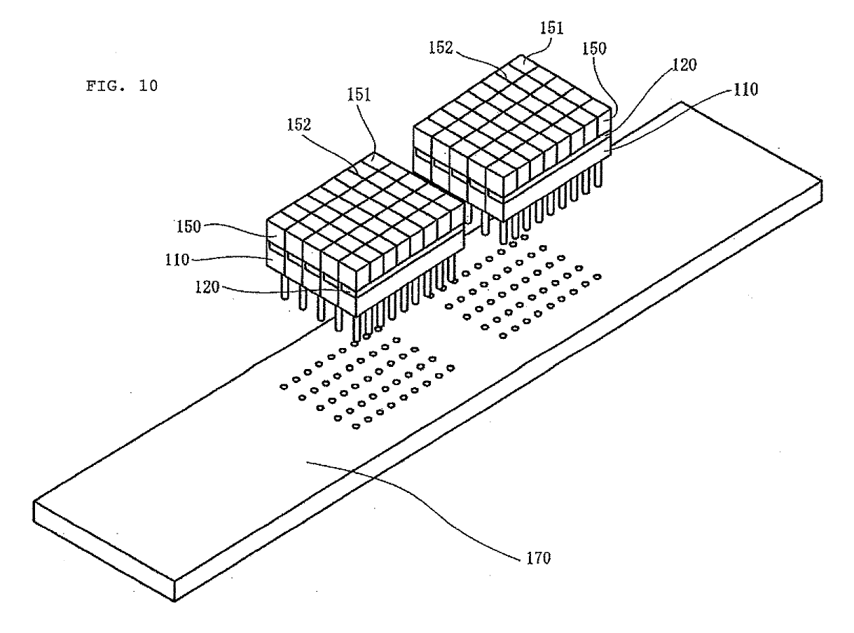

Moreover, by arranging the photo detectors 10 in a matrix pattern (in a three-dimensional pattern) as shown in FIG. 4, the photo detectors 10 can configure a photo detection apparatus 50 that can convert a wide range of lights into an electrical signal. In particular, since the substrate for connecting the photo detection element 22 is the flexible wiring substrate 30 having flexibility for the photo detector 10 that configures the photo detection apparatus 50, the wiring substrate can be bent down below the photo detector and the photo detectors 10 can be arranged in a matrix pattern (in a three-dimensional pattern) in a wide range to suitably configure a photo detection apparatus 50.

As shown in FIG. 5, a scintillator element 60 can be disposed on the upper surface of the photo detection element 22 of the photo detection apparatus 50 shown in FIG. 4 to obtain a desired data by converting an X-ray in particular into an electrical signal.

By the above configuration, the scintillator element 60 converts an X-ray into a visible light, and the photo detection element 22 converts the visible light into an electrical signal to obtain a desired data.

Consequently, in the case in which the photo detection apparatus 50 shown in FIG. 5 is mounted to an X-ray CT system in particular, an internal state of a desired region of the subject can be obtained in a sliced pattern. In addition, since the photo detectors 10 in accordance with the present invention are arranged in a matrix pattern (in a three-dimensional pattern) to configure the photo detection apparatus 50, a plurality of slice data can be obtained at one time and a volume of X-rays irradiated to the subject can be suppressed, thereby enabling a low-impact examination for the subject.

While the preferred embodiments of the photo detector and the photo detection apparatus in accordance with the present invention have been described above, the present invention is not restricted to the embodiments, and various changes, modifications, and functional additions can be thus made without departing from the scope of the present invention.

1. A photo detector for generating an electrical signal based on the intensity of a light received by a photo detection element, the photo detector comprising:
a flexible wiring substrate for mounting the photo detection element; and
the photo detection element electrically connected to the flexible wiring substrate for mounting the photo detection element.

2. The photo detector according to claim 1, wherein the flexible wiring substrate for mounting the photo detection element is connected to the photo detection element by a bonding wire.

3. The photo detector according to claim 1, wherein the flexible wiring substrate for mounting the photo detection element is connected to the photo detection element by a ball grid array (BGA).

4. The photo detector according to claim 1, wherein the photo detection element is electrically connected to one side face of the flexible wiring substrate for mounting the photo detection element and a reinforcing board is formed on the other side face.

5. The photo detector according to claim 1, wherein the photo detection element configures an element aggregate composed of a plurality of photo detection elements.

6. The photo detector according to claim 5, wherein the element aggregate is composed of a plurality of photo detection elements arranged in a line pattern.

7. The photo detector according to claim 5, wherein the element aggregate is composed of a plurality of photo detection elements arranged in a matrix pattern.

8. The photo detector according to claim 1, further comprising a scintillator element disposed on the position corresponding to the photo detection element, the scintillator element converting a light having a predetermined wavelength into a visible light.

9. The photo detector according to claim 8, wherein the light having a predetermined wavelength is an X-ray.

10. The photo detector according to claim 1, wherein the photo detection element is a photodiode.

11. A photo detection apparatus wherein the photo detectors according to claim 1 are arranged in a line pattern.

12. A photo detection apparatus wherein the photo detectors according to claim 1 are arranged in a matrix pattern.
